(19) United States
(12) Patent Application Publication
(10) Pub. No.: US 2013/0145027 A1
(43) Pub. Date: Jun. 6, 2013

(54) REGULATORY COMPLIANCE ACROSS DIVERSE ENTITIES

(71) Applicants: Srivatsan Parthasarathy, Seattle, WA (US); Scott Field, Redmond, WA (US); Mario Goertzel, Bellevue, WA (US); David Kays, Redmond, WA (US); Joseph Dadzie, Redmond, WA (US); Edward Reus, Woodinville, WA (US)

(72) Inventors: Srivatsan Parthasarathy, Seattle, WA (US); Scott Field, Redmond, WA (US); Mario Goertzel, Bellevue, WA (US); David Kays, Redmond, WA (US); Joseph Dadzie, Redmond, WA (US); Edward Reus, Woodinville, WA (US)

(73) Assignee: Microsoft Corporation, Redmond, WA (US)

(21) Appl. No.: 13/309,510

(22) Filed: Dec. 1, 2011

(51) Int. Cl. G06F 15/16

(52) U.S. Cl. 709/225

(57) ABSTRACT

Regulatory compliance techniques are provided for dynamically modifying access to data based on the jurisdiction a user seeking access to the data is located within. Dynamically modifying access to data provides for a more efficient and accurate solution to regulatory compliance issues faced when hosting data in a central repository. Users can be notified when their access to data is modified due to a compliance issue. In addition, an audit history can be associated with data packets that allow an administrator or the like to view the history of data packet access. Finally, signatures associated with a data packet can be used to search data store(s) to track access to information within the data packet that may have been subsequently modified.

### TECHNICAL FIELD

The subject disclosure relates to regulatory compliance across diverse entities, and more specifically to dynamically maintaining compliance in disparate jurisdictions.

### BACKGROUND

In cloud computing, data can be hosted in a centralized repository that is accessible globally, dependent on user access to the cloud. While offering streamlined convenience and efficiency to the user who can access data from many different locations, each location the user accesses the cloud from may have differing laws and requirements in regards to the accessing of the data. Prior to the implementation of cloud computing, data, for the most part, existed locally on the storage device of electronic equipment such as a phone, tablet computer, laptop computer, or desktop computer. When a user of a laptop, for example, traveled from Paris to Berlin, an excel spreadsheet the user was working on that resided on the on the laptop could be accessed in both France and Germany without regulatory compliance issues due to the user having local access to the spreadsheet and not being dependent on access to a data repository.

With the advent of cloud computing, the same laptop user in the previous example may access and store the spreadsheet in the cloud data store using, for example, an internet connection. When moving jurisdictions from France to Germany, the user may be beholden to differing regulatory laws in regards to data hosting, data privacy, and other compliance issues. One method to ensure regulatory compliance would be to host data separately in each disparate jurisdiction. Each jurisdiction would have a separate data repository acting under the rules of the local jurisdiction. A user who changes jurisdictions would also change the data repository in which the user is accessing. However, creating servers or mirrors in disparate jurisdictions presents challenges in maintaining data integrity and data accuracy for users in disparate jurisdictions accessing and modifying the same set of data. In addition, maintaining mirrors in every disparate jurisdiction is costly. Therefore, there exists a need to have flexible regulatory policies that are dynamically employed for users from disparate jurisdictions attempting to access the same data.

The above-described deficiencies of regulatory compliance in cloud computing are merely intended to provide an overview of some of the problems of conventional systems and techniques, and are not intended to be exhaustive. Other problems with conventional systems and techniques, and corresponding benefits of the various non-limiting embodiments described herein may become further apparent upon review of the following description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In various, non-limiting embodiments, a regulatory compliance system is provided that enables dynamic adjustments of regulatory policies depending on the jurisdiction of a user. The regulatory compliance system, in one aspect, provides for determining a jurisdiction of a user attempting to access at least one data packet among a data store. The regulatory compliance system can then at least one of authorize or deny access to the at least one data packet based upon the jurisdiction. The system further provides for determining a data type of the least one data packet. A rule template can be associated with the jurisdiction and the data type and access to the data packet can be determined, at least in part, based upon the rule template.

In yet another embodiment, the regulatory compliance system can create a signature associated with a data packet. A signature trail can then be created that is associated with the signature, wherein at least one of the user, a date, a time, or a data format can be added to the signature trail upon when a user accesses the data packet. A plurality of signature trails can be stored in memory for display to an administrator. In one embodiment, the data store can be searched for data packets associated with a signature.

These and other embodiments are described in more detail below.

### BRIEF DESCRIPTION OF THE DRAWINGS

Various non-limiting embodiments are further described with reference to the accompanying drawings in which:

FIG. 1 is a graphical diagram illustrating an exemplary, non-limiting example of a jurisdiction switch by a user;

FIG. 2 is a block diagram of an exemplary, non-limiting embodiment for a regulatory compliance system;

FIG. 3 is a block diagram of an exemplary, non-limiting embodiment for a regulatory compliance system including a data type component;

FIG. 4 is a block diagram of an exemplary, non-limiting embodiment for a regulatory compliance system including a rule template component;

FIG. 5 is a block diagram of an exemplary, non-limiting embodiment for a regulatory compliance system including a notification component;

FIG. 6 is a block diagram of an exemplary, non-limiting embodiment for a regulatory compliance system including a signature stamping component;

FIG. 7 is a block diagram of an exemplary, non-limiting embodiment for a regulatory compliance system including an auditing component;

FIG. 8 is a block diagram of an exemplary, non-limiting embodiment for a regulatory compliance system including an auditing analytics component.

FIG. 9 is a flow diagram of an exemplary, non-limiting embodiment for dynamically updating regulatory policies;

FIG. 10 is a flow diagram of an exemplary, non-limiting embodiment for dynamically updating regulatory policies including determining a data type;

FIG. 11 is a flow diagram of an exemplary, non-limiting embodiment for dynamically updating regulatory policies including storing a set of rule templates;

FIG. 12 is a flow diagram of an exemplary, non-limiting embodiment for dynamically updating regulatory policies including sending a user alert;

FIG. 13 is a flow diagram of an exemplary, non-limiting embodiment for dynamically updating regulatory policies including data packet signatures;

FIG. 14 is a flow diagram of an exemplary, non-limiting embodiment for dynamically updating regulatory policies including signature trails;

FIG. 15 is a flow diagram of an exemplary, non-limiting embodiment for dynamically updating regulatory policies including display of signature trails;

FIG. 16 is a flow diagram of an exemplary, non-limiting embodiment for dynamically updating regulatory policies including signature searching;

FIG. 17 is a block diagram representing exemplary non-limiting networked environments in which various embodiments described herein can be implemented; and

FIG. 18 is a block diagram representing an exemplary non-limiting computing system or operating environment in which one or more aspects of various embodiments described herein can be implemented.

### DETAILED DESCRIPTION

As discussed in the background, conventional methods of regulatory compliance involve separate data hosting in disparate jurisdictions. However, when using cloud services, separate data hosting centers present difficulties in maintaining data integrity, maintaining data accuracy, and constraining costs. Using the regulatory compliance system can dynamically update regulatory policies depending on the location of a user. A user who crosses a jurisdiction boundary can have their access to a data repository modified based upon the jurisdiction where they are attempting to access the data.

In addition to dynamic regulatory policy modifications based on a user's jurisdiction, auditing tools associated with the regulatory policy system allow an administrator or the like to track access to a data packet. For example, an email message stored in a data store can have a signature associated with it allowing an administrator or the like to track access to the email message. In addition, an administrator can use the signature associated with a data packet to search the data store as a means to uncover instances, where for example, a user cuts and pastes a portion of one data packet into another data packet. These auditing tools provide for a comprehensive assessment of past regulatory compliance allowing an organization to show, for example, an investigating agency or an internal auditing taskforce a historical trail of a data packet.

Other embodiments and various non-limiting examples, scenarios and implementations are described in more detail below.

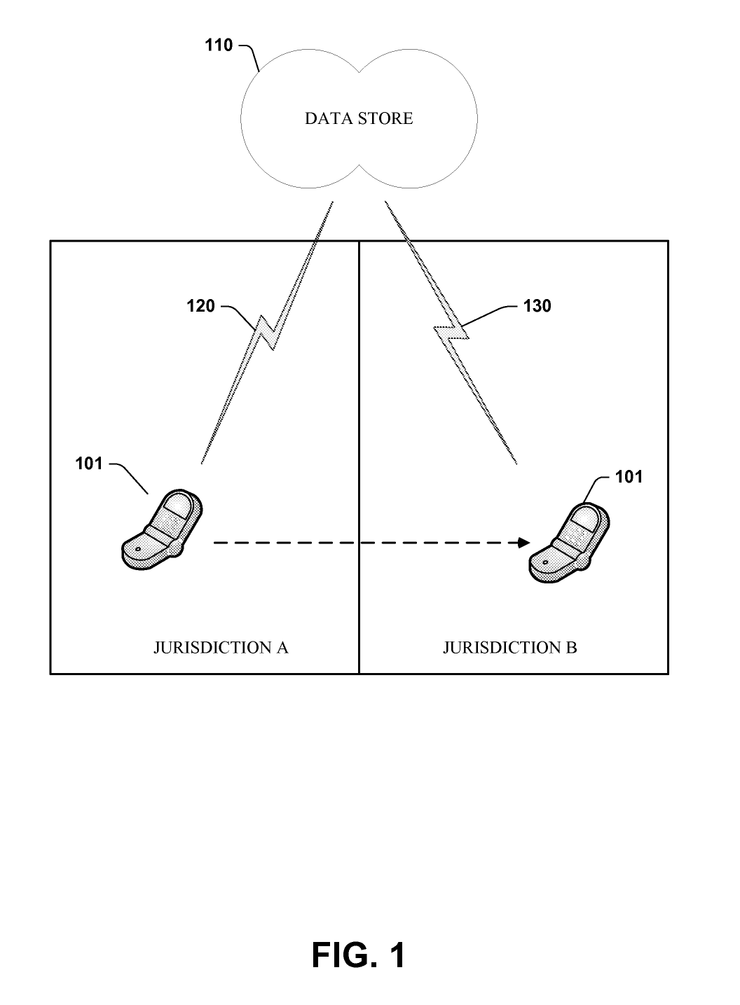

With respect to one or more non-limiting aspects of the advisory services network as described above, FIG. 1 shows a graphical diagram illustrating an exemplary, non-limiting example of a jurisdiction switch by a user. In this example, a user is connecting to data store 110 using a phone 101. First, using signal 120, phone 101 connects to data store 110. It can be appreciated that signal 120 can travel through any viable means to connect phone 101 to data store. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems as described in various embodiments.

Initially, phone 101 is accessing data store 110 using signal 120 in Jurisdiction A. However, as the phone 101 is mobile, the user of phone 101 can travel to disparate Jurisdiction B and connect to data store 110 through signal 130. It can be appreciated that jurisdictions A and B as denoted on FIG. 1 are for example only, and could represent countries, states, counties, cities, governing zones, etc. It can be appreciated that conceivably any two areas with differing regulatory policies can be established as separate jurisdictions.

If, for example, Jurisdiction B bans content, such as a book or other media, that is not similarly banned in Jurisdiction A, it is desirable that data store 110 provide access to the content in Jurisdiction A while also restricting access to the content in Jurisdiction B. Beyond establishing a data store in Jurisdiction A that contains the content banned in Jurisdiction B while also establishing a separate data store in Jurisdiction B that does not contain the banned content, systems and methods described herein provide for automatically adjusting phone 101 access to content in data store 110 based upon the jurisdiction where phone 101 is located.

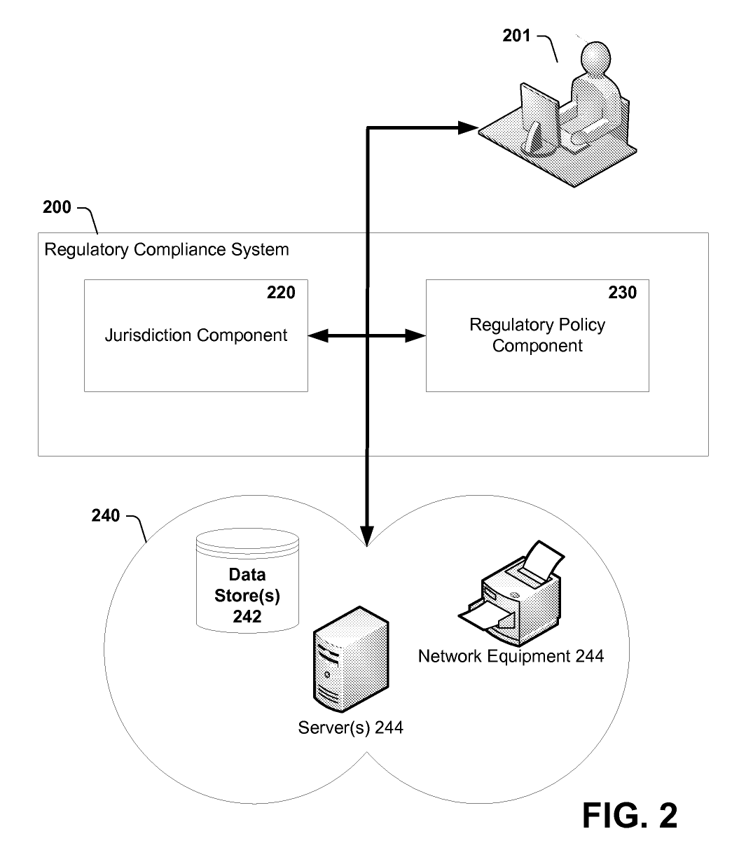

Turning now to FIG. 2, there is illustrated a block diagram of an exemplary, non-limiting embodiment for a regulatory compliance system 200. A jurisdiction component 220 can be configured to determine a jurisdiction of a user 101 attempting to access at least one data packet among a data store(s) 242. It can be appreciated that data store(s) 242 can provide to user 101 application data, files, communication data, etc. It can be further appreciated that data store(s) 242 can be within cloud computing environment 240 along with a plurality of server(s) 244 and a plurality of network equipment 244. In one embodiment, user 201 can strictly be accessing data store(s) 242 outside of a cloud computing environment.

Jurisdiction component 220 can determine a jurisdiction of user 101 using for example, GPS tracking, IP address tracking, or other known methods for geographically locating an end user in a communication network. Geographical locations can be associated with a jurisdiction. In alternate embodiments non-geographical means indicative of jurisdiction location can be used to determine a jurisdiction such as a network type or association.

Regulatory policy component 230 can modify access to the at least one data packet based upon the jurisdiction. For example, certain data packets can be inaccessible in jurisdictions where such content is banned. Data packets may be constrained in that a jurisdiction may prevent data from flowing into another jurisdiction. Hardware and/or features of a user 101 device may be constrained wherein data store(s) 242 can prevent access to data necessary for the function of such hardware or features. For example, data associated with placing a Voice over Internet Protocol (VoIP) phone call may be restricted in a jurisdiction that forbids such services. It can be appreciated that regulatory policies are generally established by governing bodies and are adaptable and subject to change as are the modifications made by regulatory policy component 230.

In another example, applications may require application data associated with using the application. Thus, in one embodiment, regulatory policy modifications can be made by regulatory policy component 230 instead of being dependent on each application having the requisite regulatory knowledge to prevent improper or unlawful access to such data.

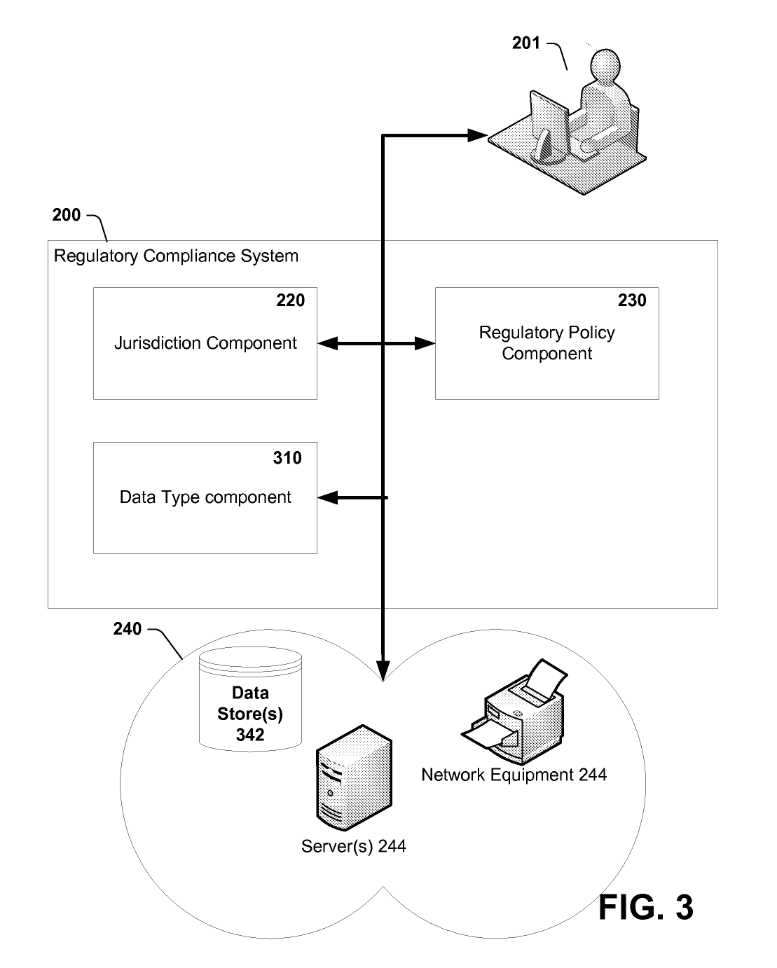

Turning now to FIG. 3, there is illustrated a block diagram of an exemplary, non-limiting embodiment for a regulatory compliance system 200 including a data type component 310 that can be configured to determine a data type of the at least one data packet. For example, a data type in embodiment can be personal or corporate data. It can be appreciated that a jurisdiction may have different policies and procedures in place for differing types of data. Some jurisdictions place greater privacy restraints on personal data versus corporate data for example. It can be further appreciated that other classes of data types are possible and can be used in jurisdictions where distinctions between types of data are associated with differing rules and regulations.

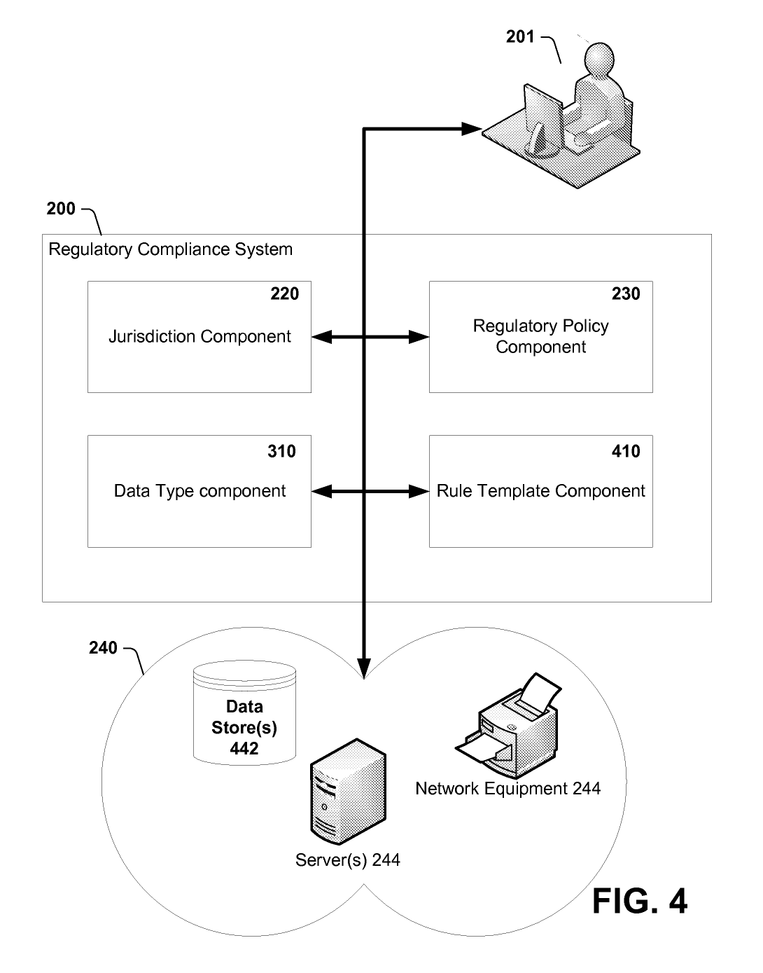

Turning now to FIG. 4, there is illustrated a block diagram of an exemplary, non-limiting embodiment for a regulatory compliance system including a rule template component 410 that can be configured to store a set of rule templates in a memory wherein a rule template is associated with at least one jurisdiction and at least one data type. It can be appreciated that rule the memory can be local to regulatory compliance system 200 or alternatively stored within cloud 240. Each jurisdiction can have a rule template associated with the jurisdiction with some jurisdiction having multiple templates based on the type of data user 101 is seeking to access. Rule templates associated with the jurisdiction user 101 is located within and the type of data user 101 is seeking to access can be employed by regulatory policy component 230 which can use the employed rule templates in modifying access to the at least one data packet.

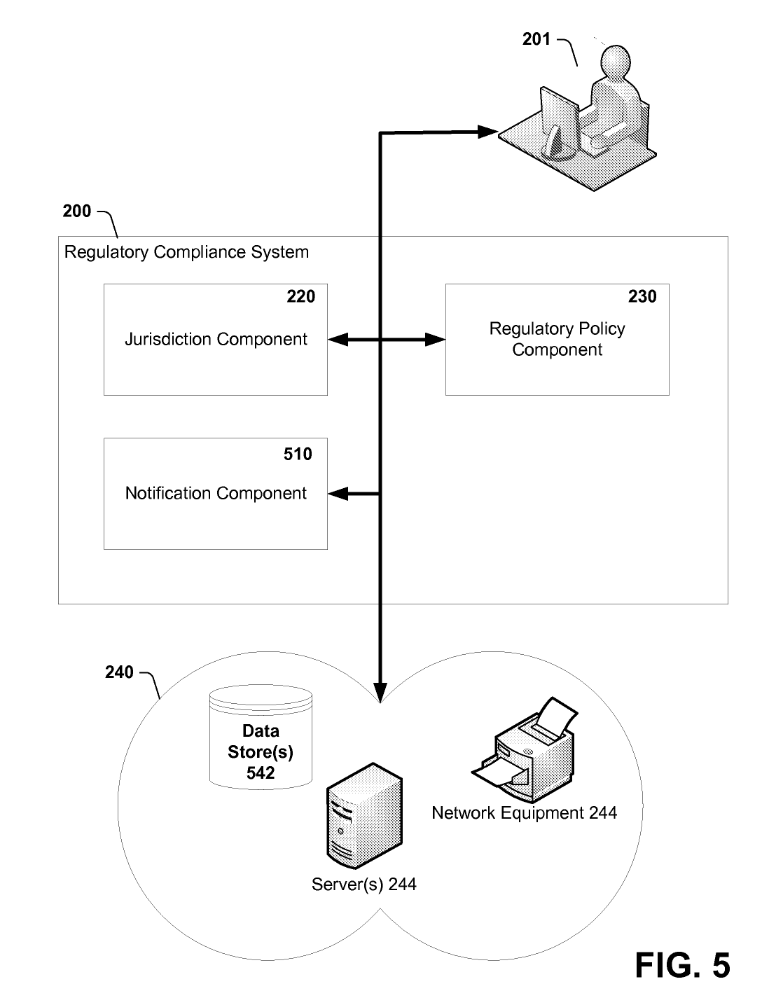

Turning now to FIG. 5, there is illustrated a block diagram of an exemplary, non-limiting embodiment for a regulatory compliance system including a notification component 510 that can be configured to send an alert to the user based upon any modifying of access by regulatory policy component 230. For example, in the instance where certain content is banned, notification component 510 can alert user 101 that the data user 101 is seeking to accessing in data store 242 is banned in the jurisdiction in which user 101 currently is located within.

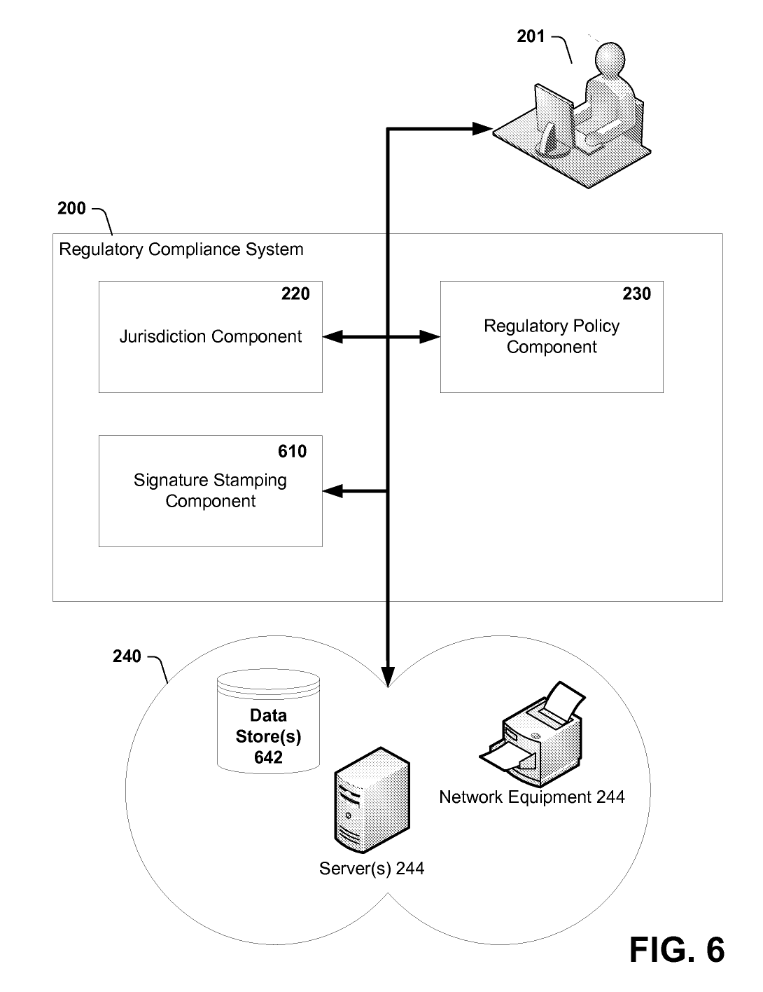

Turning now to FIG. 6, there is illustrated a block diagram of an exemplary, non-limiting embodiment for a regulatory compliance system including a signature stamping component 610 configured to at least one of identify or create a signature associated with the at least one data packet. For example, a signature could be a watermark associated with a document. The signature could be a section of code added to data or data packets. It can be appreciated the means of employing the signature are many and under any signature scheme, the signature can provide for the tracking of the signature.

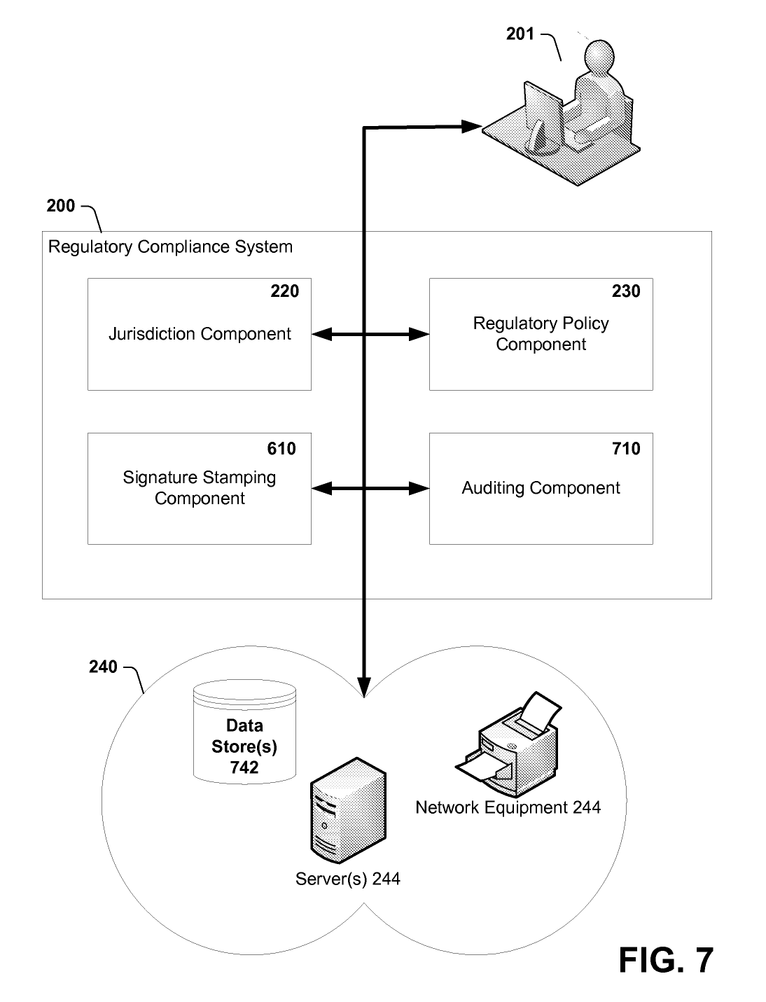

Turning now to FIG. 7, there is illustrated a block diagram of an exemplary, non-limiting embodiment for a regulatory compliance system including an auditing component 710 that can be configured to at least one of create or modify a signature trail associated with the signature. A signature trail can be a historical timeline containing fields such as the user who accessed the data packet, the time the data packet was accessed, a format of the data, a denial of access, etc. When user 101 attempts to access a data packet, auditing component 710 can modify the signature trail associated with the data packet to add information associated with the users attempted access. If no signature trail exists for the data packet, auditing component 710 can create a signature trail.

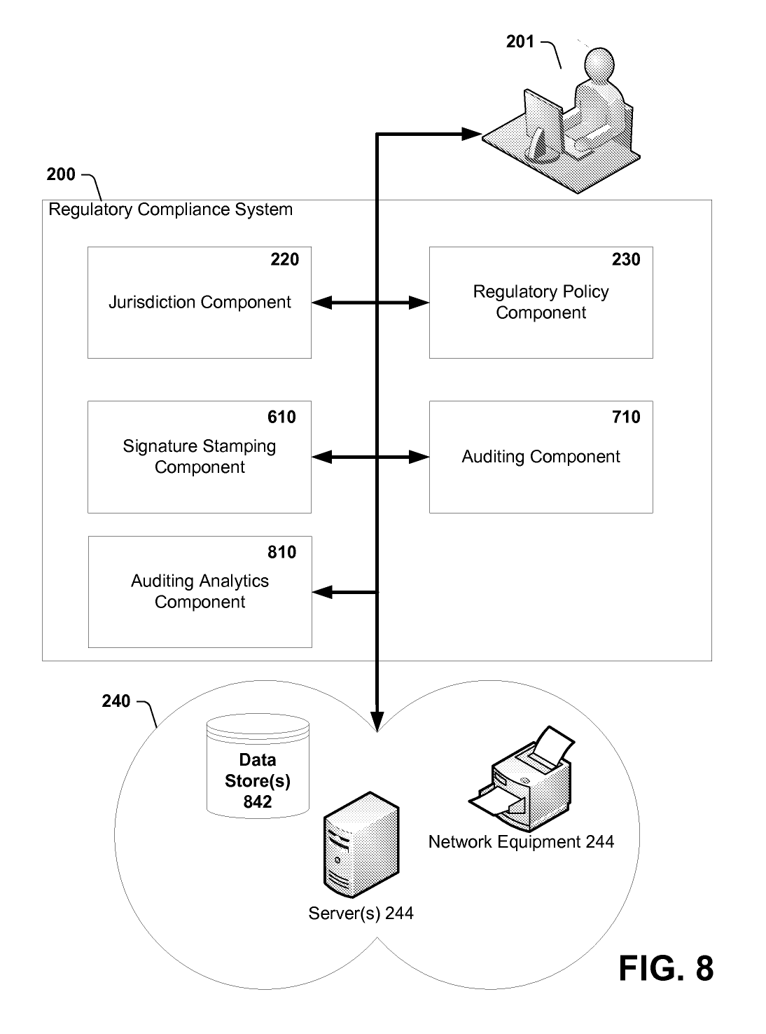

Turning now to FIG. 8, there is illustrated a block diagram of an exemplary, non-limiting embodiment for a regulatory compliance system including an auditing analytics component 810 that can be configured to at least one of update or store the signature trail among a plurality of signature trails capable of being displayed to an administrator. For example, a memory local to regulatory compliance system 200 or in another example within data store(s) 242 can contain the plurality of signature trails. Upon creation or modification by auditing component 710, auditing analytics components can update the stored signature trail.

In one embodiment, auditing analytics component 810 can be further configured to search the data store(s) 242 for data packets associated with a signature. For example, an email message containing a signature may be cut and pasted into a separate file stored as a separate data packet in data store(s) 242 by user 101. Auditing analytics component 810 can uncover instances where sections of data have been moved to new files or new documents to determine the dissemination of information. For example, signature trails associated with two data packets containing the same signature can be aggregated to give a complete picture to the access of content associated with a signature.

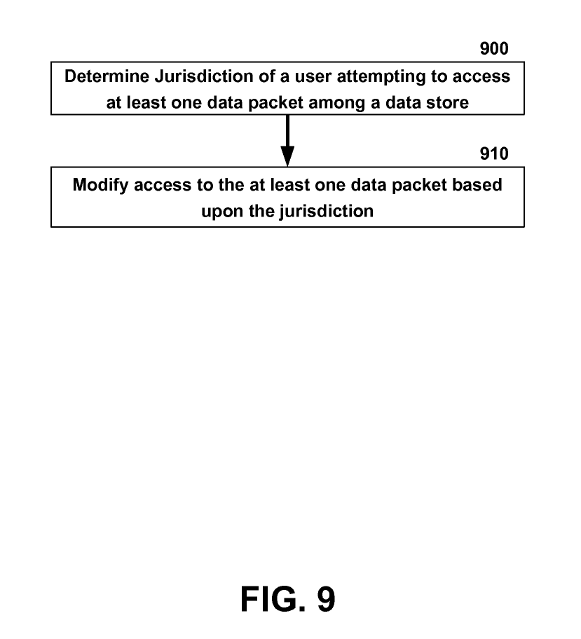

FIGS. 9-16 illustrate methodologies and/or flow diagrams in accordance with this disclosure. For simplicity of explanation, the methodologies are depicted and described as a series of acts. However, acts in accordance with this disclosure can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be appreciated that the methodologies disclosed in this specification are capable of being stored on an article of manufacture to facilitate transporting and transferring such methodologies to computing devices. The term article of manufacture, as used herein, is intended to encompass a computer program accessible from any computer-readable device or storage media.

Moreover, various acts have been described in detail above in connection with respective system diagrams. It is to be appreciated that the detailed description of such acts in the prior figures can be and are intended to be implementable in accordance with the following methodologies.

Turning now to FIG. 9, there is illustrated a flow diagram of an exemplary, non-limiting embodiment for dynamically updating regulatory policies. At 900, a jurisdiction of a user attempting to access at least one data packet among a data store can be determined. At 910, access can be modified to the at least one data packet based upon the jurisdiction.

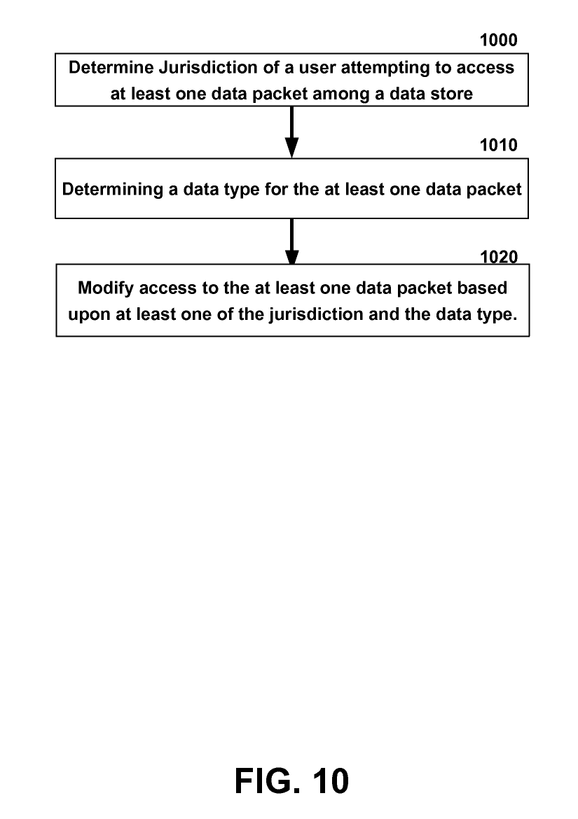

Turning now to FIG. 10, there is illustrated a flow diagram of an exemplary, non-limiting embodiment for dynamically updating regulatory policies including determining a data type. At 1000, a jurisdiction of a user attempting to access at least one data packet among a data store can be determined. At 1010, a data type for the at least one data packet can be determined. At 1020, access can be modified to the at least one data packet based upon at least one of the jurisdiction or the data type.

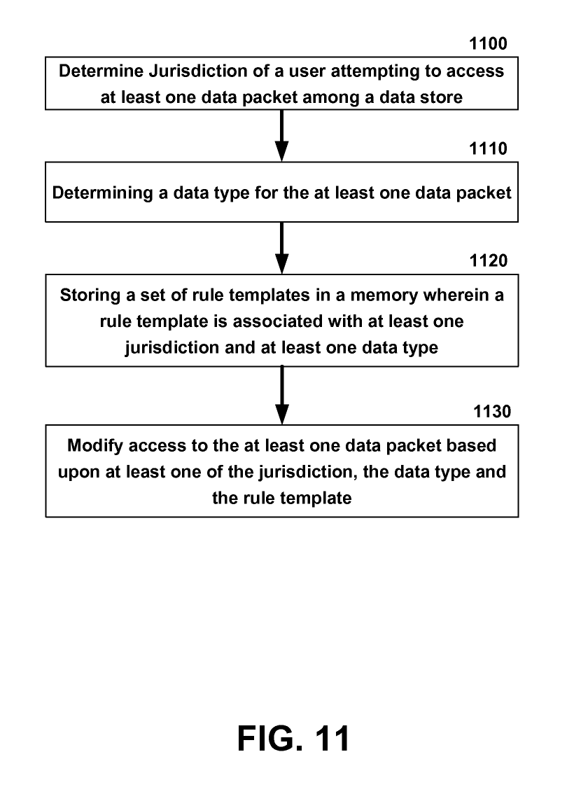

Turning now to FIG. 11, there is illustrated a flow diagram of an exemplary, non-limiting embodiment for dynamically updating regulatory policies including storing a set of rule templates. At 1100, a jurisdiction of a user attempting to access at least one data packet among a data store can be determined. At 1110, a data type for the at least one data packet can be determined. At 1120, a set of rule templates can be stored in a memory wherein a rule template is associated with at least one jurisdiction and at least one data type. At 1130, access can be modified to the at least one data packet based upon at least one of the jurisdiction, the data type, or the rule template.

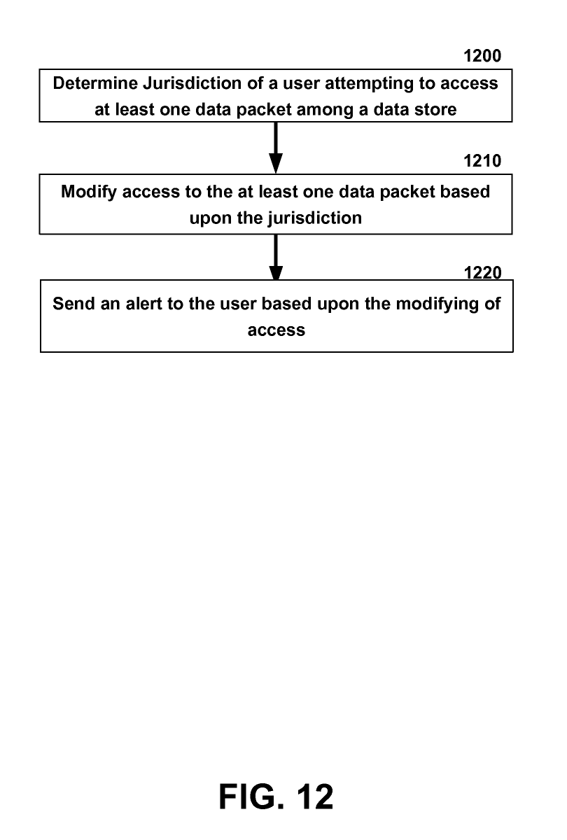

Turning now to FIG. 12, there is illustrated a flow diagram of an exemplary, non-limiting embodiment for dynamically updating regulatory policies including sending a user alert. At 1200, a jurisdiction of a user attempting to access at least one data packet among a data store can be determined. At 1210, access can be modified to the at least one data packet based upon the jurisdiction. At 1220, an alert can be sent to the user based upon the modifying of access.

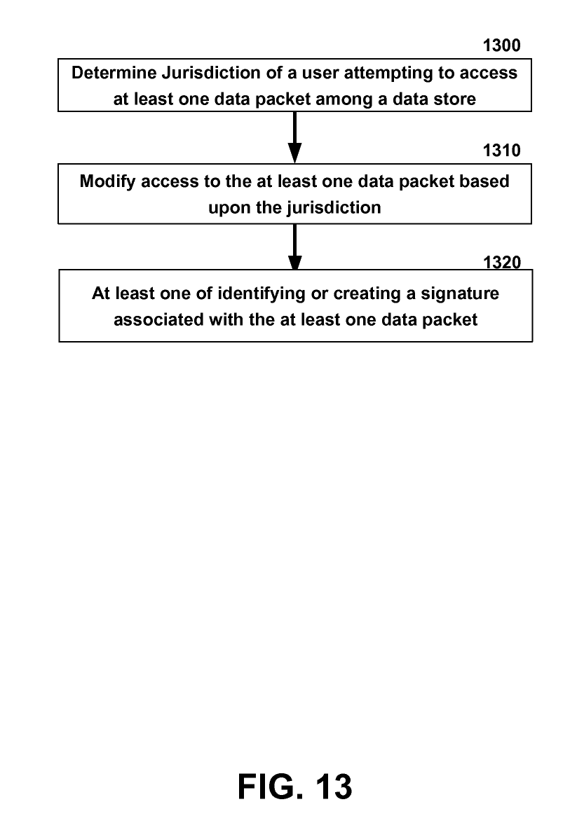

Turning now to FIG. 13, there is illustrated a flow diagram of an exemplary, non-limiting embodiment for dynamically updating regulatory policies including data packet signatures. At 1300, a jurisdiction of a user attempting to access at least one data packet among a data store can be determined. At 1310, access can be modified to the at least one data packet based upon the jurisdiction. At 1320, a signature associated with the at least one data packet can be at least one of identified of created.

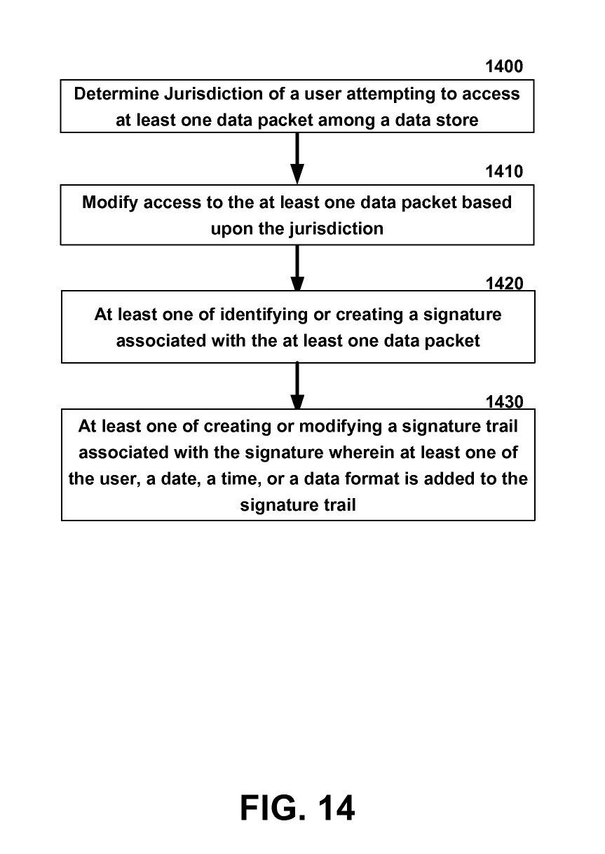

Turning now to FIG. 14, there is illustrated a flow diagram of an exemplary, non-limiting embodiment for dynamically updating regulatory policies including signature trails. At 1400, a jurisdiction of a user attempting to access at least one data packet among a data store can be determined. At 1410, access can be modified to the at least one data packet based upon the jurisdiction. At 1420, a signature associated with the at least one data packet can be at least one of identified of created. At 1430, a signature trail associated with the signature can be at least one of created or modified. A signature trail can be a historical timeline containing fields such as the user who accessed the data packet, the time the data packet was accessed, a format of the data, a denial of access, etc. When the user attempts to access a data packet, the method provides for modifying the signature trail associated with the data packet to add information associated with the users attempted access. If no signature trail exists for the data packet, the methodology provides for a signature trail to be created.

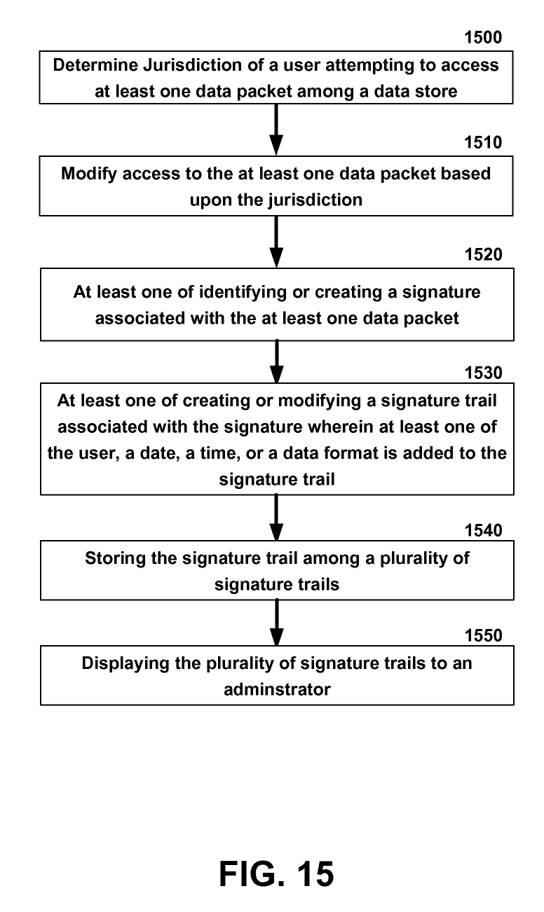

Turning now to FIG. 15, there is illustrated a flow diagram of an exemplary, non-limiting embodiment for dynamically updating regulatory policies including display of signature trails. At 1500, a jurisdiction of a user attempting to access at least one data packet among a data store can be determined. At 1510, access can be modified to the at least one data packet based upon the jurisdiction. At 1520, a signature associated with the at least one data packet can be at least one of identified of created. At 1530, a signature trail associated with the signature can be at least one of created or modified. At 1540, the created or modified signature trail can be stored among a plurality of signature trail. At 1550, the plurality of signature trails can be displayed to an administrator of the system or the like.

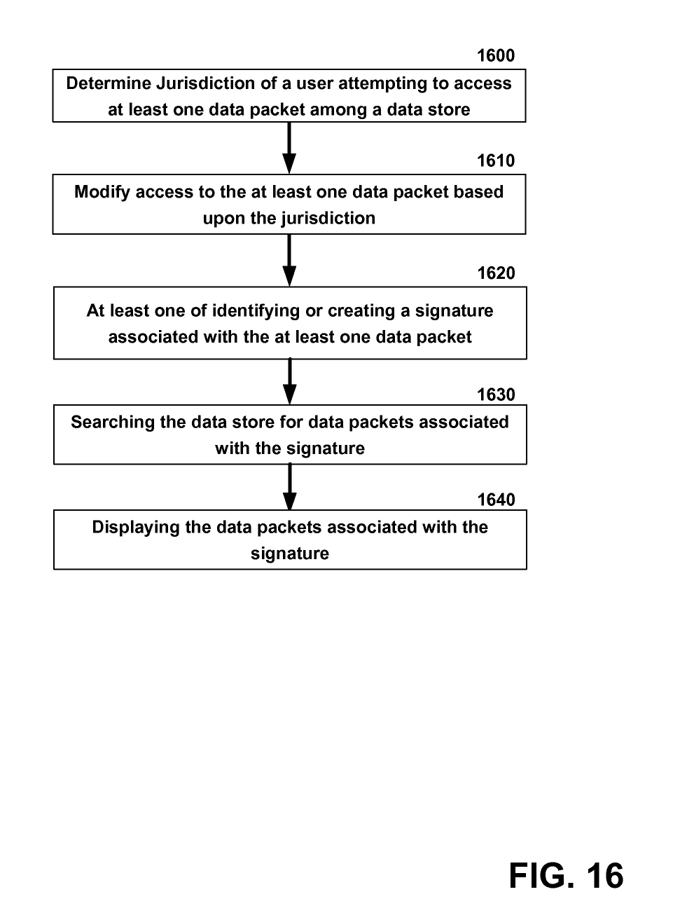

Turning now to FIG. 16, there is illustrated a flow diagram of an exemplary, non-limiting embodiment for dynamically updating regulatory policies including signature searching. At 1600, a jurisdiction of a user attempting to access at least one data packet among a data store can be determined. At 1610, access can be modified to the at least one data packet based upon the jurisdiction. At 1620, a signature associated with the at least one data packet can be at least one of identified of created. At 1630, the data store can be searched for data packets associated with the signature. At 1640, the data packets associated with the signature can be displayed to an administrator or the like.

### Exemplary Networked and Distributed Environments

One of ordinary skill in the art can appreciate that the various embodiments of regulatory compliance systems and methods described herein can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise.

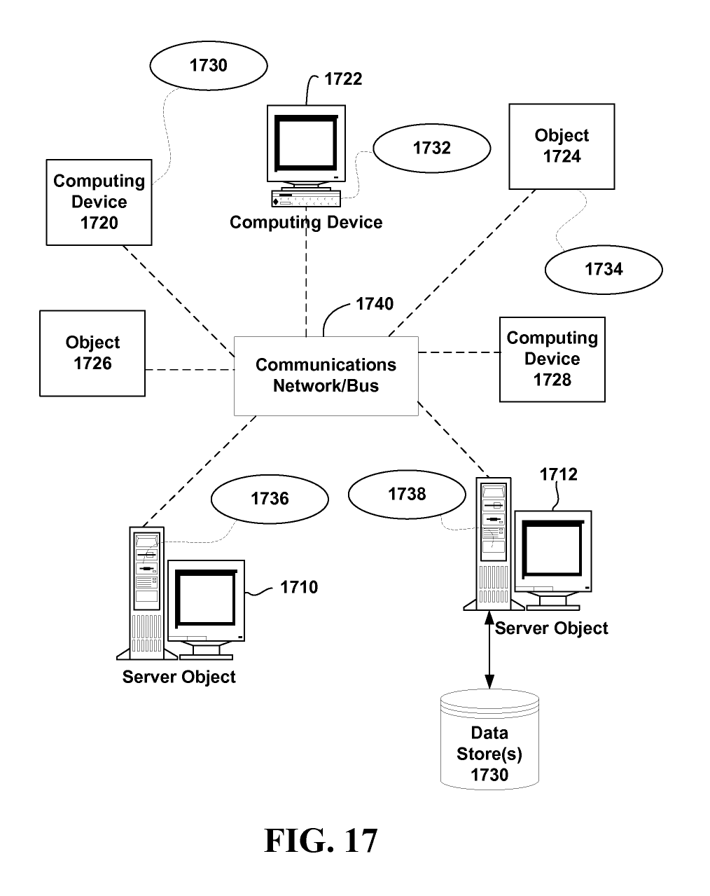

FIG. 17 provides a schematic diagram of an exemplary networked or distributed computing environment. The distributed computing environment comprises computing objects 1710, 1712, etc. and computing objects or devices 1720, 1722, 1724, 1726, 1728, etc., which may include programs, methods, data stores, programmable logic, etc., as represented by applications 1730, 1732, 1734, 1736, 1738. It can be appreciated that computing objects 1710, 1712, etc. and computing objects or devices 1720, 1722, 1724, 1726, 1728, etc. may comprise different devices, such as personal digital assistants (PDAs), audio/video devices, mobile phones, MP3 players, personal computers, laptops, etc.

Each computing object 1710, 1712, etc. and computing objects or devices 1720, 1722, 1724, 1726, 1728, etc. can communicate with one or more other computing objects 1710, 1712, etc. and computing objects or devices 1720, 1722, 1724, 1726, 1728, etc. by way of the communications network 1740, either directly or indirectly. Even though illustrated as a single element in FIG. 17, communications network 1740 may comprise other computing objects and computing devices that provide services to the system of FIG. 17, and/or may represent multiple interconnected networks, which are not shown. Each computing object 1710, 1712, etc. or computing object or device 1720, 1722, 1724, 1726, 1728, etc. can also contain an application, such as applications 1730, 1732, 1734, 1736, 1738, that might make use of an API, or other object, software, firmware and/or hardware, suitable for communication with or implementation of the regulatory compliance systems and methods provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 17, as a non-limiting example, computing objects or devices 1720, 1722, 1724, 1726, 1728, etc. can be thought of as clients and computing objects 1710, 1712, etc. can be thought of as servers where computing objects 1710, 1712, etc., acting as servers provide data services, such as receiving data from client computing objects or devices 1720, 1722, 1724, 1726, 1728, etc., storing of data, processing of data, transmitting data to client computing objects or devices 1720, 1722, 1724, 1726, 1728, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 1740 or bus is the Internet, for example, the computing objects 1710, 1712, etc. can be Web servers with which other computing objects or devices 1720, 1722, 1724, 1726, 1728, etc. communicate via any of a number of known protocols, such as the hypertext transfer protocol (HTTP). Computing objects 1710, 1712, etc. acting as servers may also serve as clients, e.g., computing objects or devices 1720, 1722, 1724, 1726, 1728, etc., as may be characteristic of a distributed computing environment.

### Exemplary Computing Device

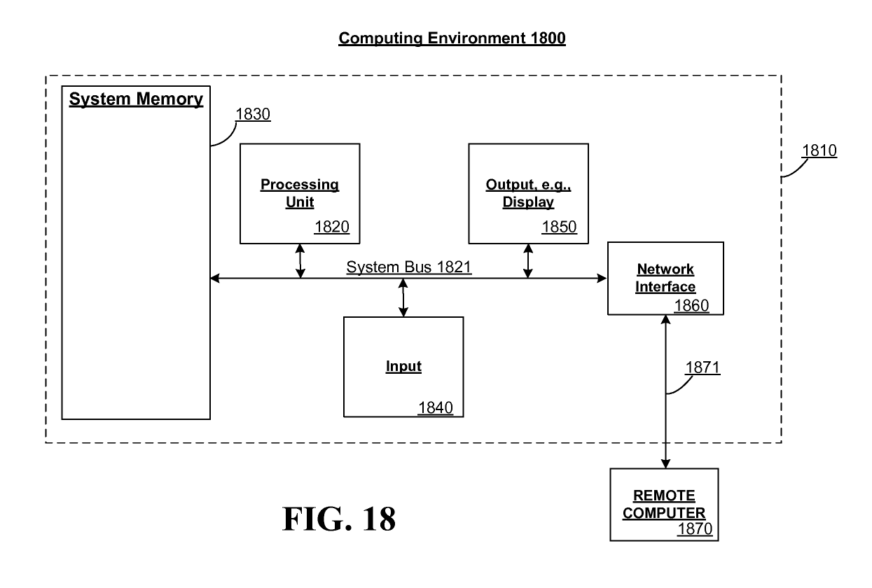

As mentioned, advantageously, the techniques described herein can be applied to any device where it is desirable to achieve regulatory compliance. It can be understood, therefore, that handheld, portable and other computing devices and computing objects of all kinds are contemplated for use in connection with the various embodiments, i.e., anywhere where regulatory compliance is implicated. Accordingly, the below general purpose remote computer described below in FIG. 18 is but one example of a computing device.

Embodiments can partly be implemented via an operating system, for use by a developer of services for a device or object, and/or included within application software that operates to perform one or more functional aspects of the various embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 18 thus illustrates an example of a suitable computing system environment 1800 in which one or aspects of the embodiments described herein can be implemented, although as made clear above, the computing system environment 1800 is only one example of a suitable computing environment and is not intended to suggest any limitation as to scope of use or functionality. In addition, the computing system environment 1800 is not intended to be interpreted as having any dependency relating to any one or combination of components illustrated in the exemplary computing system environment 1800.

With reference to FIG. 18, an exemplary remote device for implementing one or more embodiments includes a general purpose computing device in the form of a computer 1810. Components of computer 1810 may include, but are not limited to, a processing unit 1820, a system memory 1830, and a system bus 1822 that couples various system components including the system memory to the processing unit 1820.

Computer 1810 typically includes a variety of computer readable media and can be any available media that can be accessed by computer 1810. The system memory 1830 may include computer storage media in the form of volatile and/or nonvolatile memory such as read only memory (ROM) and/or random access memory (RAM). By way of example, and not limitation, system memory 1830 may also include an operating system, application programs, other program modules, and program data. According to a further example, computer 1810 can also include a variety of other media (not shown), which can include, without limitation, RAM, ROM, EEPROM, flash memory or other memory technology, compact disk (CD)-ROM, digital versatile disk (DVD) or other optical disk storage, magnetic cassettes, magnetic tape, magnetic disk storage or other magnetic storage devices, or other tangible and/or non-transitory media which can be used to store desired information.

A user can enter commands and information into the computer 1810 through input devices 1840. A monitor or other type of display device is also connected to the system bus 1822 via an interface, such as output interface 1850. In addition to a monitor, computers can also include other peripheral output devices such as speakers and a printer, which may be connected through output interface 1850.

The computer 1810 may operate in a networked or distributed environment using logical connections to one or more other remote computers, such as remote computer 1870. The remote computer 1870 may be a personal computer, a server, a router, a network PC, a peer device or other common network node, or any other remote media consumption or transmission device, and may include any or all of the elements described above relative to the computer 1810. The logical connections depicted in FIG. 18 include a network 1872, such as a local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to provide incentives for gaming input.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be affected across a plurality of devices. Accordingly, the invention is not to be limited to any single embodiment, but rather is to be construed in breadth, spirit and scope in accordance with the appended claims.

What is claimed is:

1. A regulatory compliance system comprising:
a jurisdiction component configured to determine a jurisdiction of a user attempting to access at least one data packet of a data store; and
a regulatory policy component configured to modify access to the at least one data packet based upon the jurisdiction.

2. The regulatory compliance system of claim 1, further comprising:
a data type component configured to determine a data type of the at least one data packet.

3. The regulatory compliance system of claim 2, wherein the data type is at least one of personal data or corporate data.

4. The regulatory compliance system of claim 2, wherein the regulatory policy component is configured to modify access to the at least one data packet further based upon the data type.

5. The regulatory compliance system of claim 2, further comprising:
a rule template component configured to store a set of rule templates in a memory wherein a rule template is associated with at least one jurisdiction and at least one data type.

6. The regulatory compliance system of claim 1, further comprising:
a notification component configured to send an alert to the user based upon the modify access.

7. The regulatory compliance system of claim 1, further comprising:
a signature stamping component configured to at least one of identify or create a signature associated with the at least one data packet.

8. The regulatory compliance system of claim 7, further comprising:
an auditing component configured to at least one of create or modify a signature trail associated with the signature wherein at least one of the user, a date, a time, or a data format is added to the signature trail.

9. The regulatory compliance system of claim 8, further comprising:
an auditing analytics component configured to at least one of update or store the signature trail among a plurality of signature trails capable of being displayed to an administrator.

10. A method facilitated by at least one processor of a computing system, comprising:
determining a jurisdiction of a user attempting to access at least one data packet among a data store; and
modifying access to the at least one data packet based upon the jurisdiction.

11. The method of claim 10, further comprising:
storing a set of rule templates in a memory wherein a rule template is associated with at least one jurisdiction and at least one data type,
wherein the modifying access to the at least one data packet is further based upon at least one rule template associated with the jurisdiction and the data type.

12. The method of claim 10, further comprising:
sending an alert to the user based upon the modifying access.

13. The method of claim 10, further comprising:
at least one of identifying or creating a signature associated with the at least one data packet;
at least one of creating or modifying a signature trail associated with the signature wherein at least one of the user, a date, a time, or a data format is added to the signature trail;
storing the signature trail among a plurality of signature trails; and
displaying the plurality of signature trails to an administrator.

14. The method of claim 13, further comprising:
searching the data store for data packets associated with the signature; and
displaying the data packets associated with the signature.

15. A computer-readable storage medium comprising computer-readable instructions that, in response to execution, cause a computing system including at least one processor to perform operations, comprising:
determining a jurisdiction of a user attempting to access at least one data packet among a data store; and
modifying access to the at least one data packet based upon the jurisdiction.

16. The computer-readable storage medium of claim 15, further comprising:
determining a data type of the at least one data packet.

17. The computer-readable storage medium of claim 16, wherein the data type is at least one of personal data or corporate data.

18. The computer-readable storage medium of claim 16, wherein the modifying access to the at least one data packet is further based upon the data type.

19. The computer-readable storage medium of claim 16, the operations further comprising:
storing a set of rule templates in a memory wherein a rule template is associated with at least one jurisdiction and at least one data type,
wherein the modifying access to the at least one data packet is further based upon at least one rule template associated with the jurisdiction and the at least one data type.

20. The computer-readable storage medium of claim 15, the operations further comprising:
sending an alert to the user based upon authorizing or denial of access.
